(19) United States
(12) Patent Application Publication
(10) Pub. No.: US 2020/0030640 A1
(43) Pub. Date: Jan. 30, 2020

(54) EXTRICATION RESCUE TOOL

(71) Applicant: N.V. HOLMATRO, Raamsdonksveer (NL)

(72) Inventors: Rene Wilhelmus Johannes VAN EINDHOVEN, OISTERWIJK (NL); Adrianus Cornelis Maria JACOBS, BOSSCHENHOOFD (NL)

(73) Assignee: N.V. HOLMATRO, Raamsdonksveer (NL)

(21) Appl. No.: 16/488,298

(22) PCT Filed: Feb. 20, 2018
(86) PCT No.: PCT/NL2018/050113

§ 371 Date: Aug. 23, 2019

(30) Foreign Application Priority Data
Feb. 24, 2017 (NL) 2018422

(51) Int. Cl. A62B 3/00; F21V 33/00

(52) U.S. Cl. CPC A62B 3/005; F21V 33/0064

(57) ABSTRACT

An extrication rescue tool, configured to open an extrication passage for extricating a victim in a plight, such as a car wreck or a collapsed building. The extrication rescue tool includes a extendable element, which is selectively extendable by a drive along an extension path and configured to forcibly maintain or enlarge an extrication passage to thereby allow extrication of the victim through the extrication passage. When the extendable element is extended an illuminator is oriented along the extension path of the extendable element to identify obstacles in the extension path.

The present disclosure relates to an extrication rescue tool, configured to open an extrication passage for extricating a victim in a plight, such as a car wreck or a collapsed building, from a group of extrication rescue tools comprising a ram, a shoring tool and a power strut.

Such extrication rescue tools are generally known, for example from the applicant's own International patent application with publication number WO-2011/152727 in an exemplary embodiment of a spreader, to which the present disclosure is not limited.

In addition, reference is made here to US Patent Application Publication US 2012/0298940 A1, which discloses a portable rescue cylinder comprising illumination devices for the purpose of illuminating a work area in darkness.

It is an object of the present disclosure to improve over prior art extrication rescue tools, even in ambient light circumstances. Often extrication rescue tools engage obstacles during extension of an extendable element of such tools, making strutting or enlarging an extrication passage impossible. Also, extrication rescue tools are sometimes deployed, which are in a fully extended state thereof, not long enough to strut an extrication passage or enlarge it.

There are, to the best knowledge of the inventors of the present disclosure, many examples of disclosures of tools with lighting in general to light a work space, using a diffuse general light source, such as the one known from the above acknowledged prior art publication US-2012/0298940. However, such prior art examples merely flood workspaces with light. In contrast to said publication, embodiments of the invention as described in the present disclosure comprise an illuminator configured specifically to identify obstacles in an extension path of an extendable element.

The present disclosure thus far exceeds the prior art, by the extrication rescue tool according to the present disclosure comprising:
a extendable element, which is selectively extendable by a drive along an extension path and configured to forcibly maintain or enlarge an extrication passage to thereby allow extrication of the victim through the extrication passage, when the extendable element is extended; and
an illuminator, which illuminator is associated with and oriented along the extension path of the extendable element, and is configured to project illumination in a focused shape pattern on an edge of the extrication opening to enable identification of an obstacle in the extension path, based on disturbance, by the obstacle, of the focussed shape projected by the illuminator on the edge of the extrication opening.

By deploying the extrication rescue tool according to the present disclosure, the user thereof is helped by identification of potential obstacles already when positioning the extrication rescue tool, and allows repositioning of the tool to avoid such obstacles, or take other appropriate action, because the illuminator reveals such obstacles since it is oriented along the extension path and is as a consequence associated therewith. It is worth noting that the user is most often looking from one side of the extrication passage there through, when initially positioning the extrication rescue tool, and as a consequence the user is not well positioned to accurately place the tool, such that during extension, the extendable element will not engage obstacles. Obstacles are particular for plights, such as a car wreck or a collapsed building. When deploying an extrication rescue tool, speed is of the essence to extricate plight victims as quickly as possible. Because the illuminator is associated with the extension path of the extendable element, misalignment and engagement of obstacles may be avoided or remedied, before extension along the path of the extendable element. Moreover, since the illuminator is associated with the extension path, a length thereof may be determined relatively easily, using for example a reflection sensor, to avoid deploying a tool that is too short for the job in the fully or near full extended state thereof, and allows even that extension speeds are adapted to initial and remaining distances between the tool and edges of the extrication passage.

The extrication tool of the present disclosure may exhibit a multitude of preferred embodiments, some of which may be disclosed in the below embodiment description and/or in appended dependent claims. For example:

In specific embodiments the extrication rescue tool of the present disclosure may exhibit the feature that the illuminator is configured to emit an illumination having a shape from a group, comprising at least one of a dot, a circle line, a circle with an illuminated interior, a circle with illuminated exterior, a cross hair, and the like, and/or a combination thereof.

In specific additional or alternative embodiments the extrication rescue tool of the present disclosure may exhibit the feature that at least one of a shape, size and dimension of the pattern coincides with a shape, form or size of a front of the extendable element.

In specific additional or alternative embodiments the extrication rescue tool of the present disclosure may exhibit the feature that the illuminator is arranged on a housing from which the extendable element is at least extendable and into which the extendable element is preferably also retractable.

In specific additional or alternative embodiments the extrication rescue tool of the present disclosure may exhibit the feature that the illuminator is arranged on the extendable element. In such an embodiment having the illuminator arranged on the extendable element, the illuminator may be arranged on a distal end of the extendable element.

In specific additional or alternative embodiments the extrication rescue tool of the present disclosure may exhibit the feature of further comprising at least two saddle adapters, of which one is to be arranged selectively on a distal end of the extendable element, depending on circumstances of the plight.

In embodiments having the illuminator of the distal en of the extendable element and having saddle adapters, the extrication rescue tool according to the present disclosure may exhibit the feature that the saddle adapter comprises at least one opening to pass illumination from the illuminator there through.

When the extrication rescue tool comprises saddle adapters, it may exhibit the feature that the saddle adapter comprises the illuminator.

In specific additional or alternative embodiments the extrication rescue tool of the present disclosure may exhibit the feature that the illuminator comprises a laser. Alternatives are LED's or any spotlight.

In specific additional or alternative embodiments the extrication rescue tool of the present disclosure may exhibit the feature of comprising a sensor to detect a reflection off any obstacles in the extrication passage and/or edges of the extrication passage.

In an embodiment with a reflection sensor, the extrication rescue tool according to the present disclosure may exhibit the feature of a control configured to determine, based on a detection signal from the sensor, a distance between a distal end of the extendable element and said any obstacles in the extrication passage and/or said edges of the extrication passage.

In an embodiment with a control, the extrication rescue tool according to the present disclosure may exhibit the feature that the control is configured to generate a warning, if the determined distance is larger than a length of the tool with the extendable element in a fully or near full extended state.

In an additional or alternative embodiment of the extrication rescue tool with a control according to the present disclosure may exhibit the feature that the control is connected to the drive, such as a pump feeding a cylinder, and the control is configured to accelerate the drive if the determined distance is more than a predetermined threshold value for acceleration, and to decelerate the drive if the determined distance is less than a predetermined threshold value for deceleration.

In specific additional or alternative embodiments the extrication rescue tool of the present disclosure may exhibit the feature that the drive is one from a group, at least comprising: a hydraulic cylinder, wherein the extendable element is a piston rod; an electric motor, wherein the extendable element is at least one of a spindle and a tooth rack or the like; and a linear actuator.

Herein above, embodiments of the present disclosure are referred to on the basis of relatively generic indications of features thereof, corresponding with the definitions in the appended claims. Herein below, more detailed aspects of embodiments of the present disclosure are described referring to the appended drawing. It is emphasized here that the shown embodiments are merely exemplary of the possibilities and functionalities that can be achieved with basic principles of the present disclosure, and that the scope of protection of the present disclosure as defined in the appended claims may encompass alternatives, additions and equivalents of the features and functionalities of the below described embodiments and of the features in the appended claims. Throughout the below embodiment description, the same or similar elements, components, functional units and the like can be referred to using the same or similar reference signs. In the appended drawing:

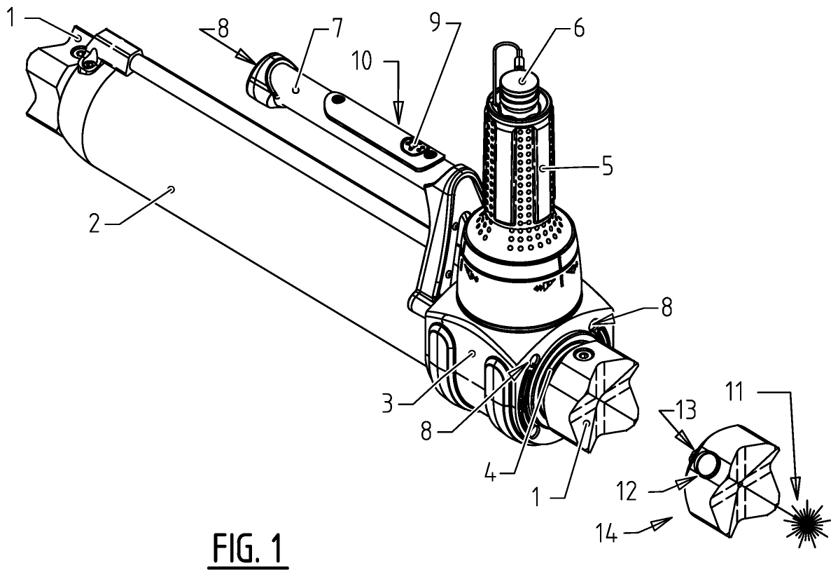

FIG. 1 shows a perspective view of the cylinder based extrication rescue ram according to the present disclosure;

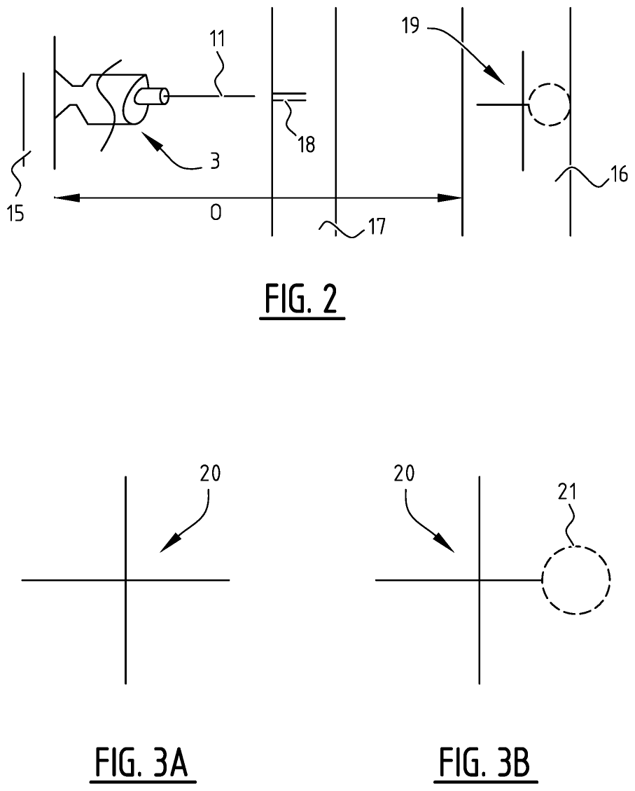

FIG. 2 shows a schematically operation of the extrication rescue ram of FIG. 1; and

FIGS. 3 to 6 show exemplary embodiments of illumination to be emitted by illuminator of the present disclosure.

FIG. 1 shows a cylinder based extrication rescue ram 3 having abutments 1 at the free end of the cylinder 2 and at the free end of a cylinder piston 4. Any one of the abutments 1 at the free end of the cylinder or of the cylinder piston 4 can optionally be provided with a saddle adapter 14. For different circumstances of a plight, different saddle adapters may de deployed, for example a broad saddle for strutting parts of a collapsed building and a narrow saddle for pressing away a beam or post of a car wreck. Selection of a suitable saddle adapter and arranging the selected saddle adapter on the piston may potentially involve replacing a previously placed saddle adapter.

The end of the piston 4 may be a tubular shape, in which case the abutment 1 is itself a saddle adapter 14 to be selected/replaced, depending on the circumstances of a plight. Alternatively the abutment may be embodied as a smallest saddle adapter, and be fixedly arranged on the distal end of the piston 4, where larger saddle adapters fit over the small abutment 1. In the embodiment of FIG. 1, the abutment 1 shown at the distal end of the piston 4 is a conventional saddle adapter without an illuminator, and the saddle adapter 14 is the—in accordance with the present disclosure—provided with the illuminator to be described in more detail herein below.

The ram 3 has a dead man grip 5, which, when released, deactivates the ram 3.

At the grip 5, are coaxial connector 6 enables input of hydraulic fluid, for example from a pump, but alternatively the pump can be incorporated into the ram 3.

On the cylinder 2, a carrying handle 7 is provided. On the carrier handle 7 on/off switch 9 is arranged, and reference sign 10 schematically denotes accommodation for batteries to supply electrical power to the electrical or electronic components.

The ram 3 comprises a number of electronic or electrical components, for example LED lighting 8, and a control (no reference sign; in the interior of the ram 3). Further, the abutment 1 and/or saddle adapter 14 is provided with a laser generator, emitting a laser beam 11. In the embodiment of FIG. 1, only the saddle adapter 14 is shown to emit a laser beam 11, but alternatively abutment 1 can alternatively or additionally be provided with its own laser generator, which can then be supplied with electrical power from the battery in the accommodation 10.

To minimise costs for expandable saddle adapters 14, it may be preferable to only incorporate a laser or other light source on the piston head or distal end of the piston 4, and provide through openings in the saddle adapters to cast illumination along the extension path. However, an illuminator such as a laser generator may be incorporated into the saddle adapter as well, without departing from the inventive concept of the present disclosure.

The laser generator can be switched on and off using switch 12, and in the embodiment of FIG. 1, wherein the laser generator is accommodated in the saddle adapter 14, the saddle adapter 14 is provided with an accommodation 13 for batteries to drive the laser generator.

The led lighting 8 and the laser generator are both positioned and arranged and oriented relative to the extendable cylinder piston 4, such that either illumination or a shadow is cast along the path along which the cylinder piston 4 extends, when driven to extend. More in particular, the led lighting 8 projects a shadow of abutment 1 or of saddle adapter 14, when provided on or over the abutment 1 at the distal end of the extendable cylinder piston 4. The laser generator can emit light in any desired pattern, which will be discussed in more detail herein below, in relation to FIGS. 3-6. Either way, any obstruction along the path will be partially or wholly illuminated and a projection on an edge of an extrication opening or passage will be affected thereby. Consequently, since the illuminator in the form of laser beam 11 from the laser is associated with the extension path of the piston 4 (rather than a wide illumination according to the prior art), it is more easily possible for a user to determine whether there is obstruction along the extension path of the cylinder piston 4.

The laser for emitting beam 11 may incorporate a sensor to detect reflection of the beam 11. Alternatively, a sensor may be separately provided. This allow a control to determine a remaining distance to an obstruction or to an edge of an extrication opening, for instance by time-of-flight determination, with which any skilled person is sufficiently acquainted to implement such distance measurements, without further elaboration here. Consequently, at the initial stages of extension of the piston 4 from the cylinder 2, a user may be warned that a resulting rain length after full extension may be insufficient to actually force open an extrication opening, allowing an operator/user to insert an extension piece or select a longer ram 3.

Additionally or alternatively, speed of extension of piston 4 out of cylinder 2 may be adapted by a control to a remaining space. In particular such a control may be the same as the one performing the remaining distance determination. For example extension speed may be high when a large distance and lot of space is available, to be reduced as the distal end of the piston (optionally carrying a saddle adapter 14) approximates an edge 16 of the extrication passage O in FIG. 2, with the ram 3 abutting against an opposing edge 15, as shown in FIG. 2. This allows the operator/user to more accurately align the ram 3, as the distal end of the piston 4 more slowly approaches the edge 16 to be forced and open the passage O further. As a result of the initially accelerated extension speed, time is saved, which is valuable in terms of time to get the plight victim extricated.

FIG. 2 also shows an obstruction 17, such as a car beam, onto which a partial projection 18 falls. This is a tell-tale sign that the obstruction will be engaged or at least clipped by the distal end of the piston 4, as it extends from the cylinder 2 of the ram 3, since the laser preferably demarcates a size of the distal end of the piston 4 and/or of a saddle adapter 14 thereon. Partial projection 18 on the obstruction 17 and/or incomplete projection 19 (encircled portion missing) on passage edge 16 allows the operator/user to deduce that an obstruction is in the way of the distal end of the piston 4. As a consequence, the operator/user can reposition the ram 3 to avoid the obstruction 17.

FIG. 3A exhibits a cross hair 20 from the laser (or other illuminator), and FIG. 3B schematically indicates an obstruction causing a portion of the cross hair 20 at circle 21 to be missing in the projection on edge 16.

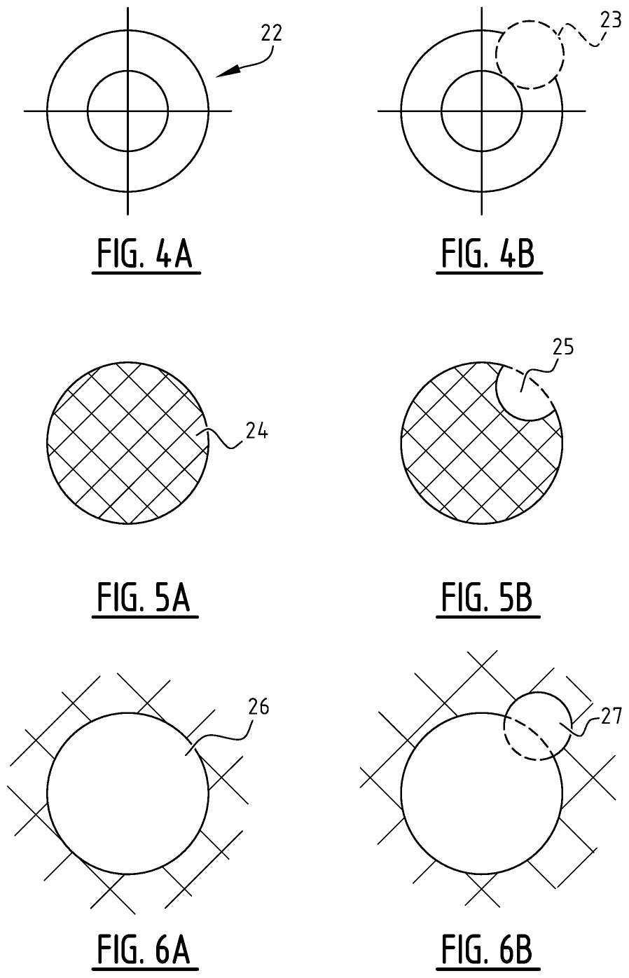

FIG. 4A exhibits a concentric circles 22 from the laser (or other illuminator), and FIG. 4B schematically indicates an obstruction causing missing portion of the concentric circles 22 at circle 23. The cross hair in these FIGS. 4A and 4B can be omitted.

FIG. 5A shows a projection of a beam onto edge 16 in the form a fully illuminated circle 24 (not just circle lines 22 as in FIG. 4), and a missing bite 25 indicates an obstruction 17 in the path of the piston 4.

FIG. 6A relates to a photonegative embodiment of the one in FIG. 5A, where illumination is generated outside a circle 26. For instance when LED's 8 are focussed, these can cast a shadow of the distal end of the piston 4 or of a saddle adapter 14 thereon, onto the edge 16. When more than the circle 26 is in the shadow, for example the additional portion 27 in FIG. 6B, this is a tell-tale sign of an obstruction 17 in the path of the piston 4.

In one embodiment of the invention according to the present disclosure, a shape, size or dimension of the illumination may coincide with a shape, size or dimension of the extendable element, the abutment 1 or saddle adapter 14. For example, referring to FIG. 4A to 6B, a shape, size or dimension of the extendable element, the abutment 1 or saddle adapter 14 may coincide with one of concentric circles 22, fully illuminated circle 26 or circle 26. Said embodiment advantageously allows for an even more reliable identification of potential obstacles when positioning the extrication rescue tool during extension of the front or head thereof. A single laser for emitting beam 11 may be employed, wherein the beam may generate a projected pattern of a cross hair, concentric circles or any shape from FIGS. 2-6. Additionally or alternatively, the front of the extrication rescue ram may comprise a number. such as two, three or more than three point lasers, demarcating on an edge of the extrication opening where the front or head or saddle adapter 14 of the extrication rescue ram will abut against the edge of the extrication opening when fully extended, so that obstacles can be clearly and reliably detected, allowing an operator to adjust positioning of the extrication rescue ram to steer clear of obstacles, during extension of the apparatus.

The present disclosure is by no means limited to the shown embodiments, or mentioned alternatives; the scope of protection is to be determined on the basis of the appended claims, and may even encompass alternatives for features and aspects of the shown and/or described embodiments and also for features defined in the appended claims. It is already noted above, for example, that alternative light sources can be used as illuminators, relative to the laser generator. Likewise, an embodiment may comprise another drive than a cylinder/pump combination, for example a linear or spindle motor. Other alternatives and additions have also been referred to already above in the preamble and the embodiment description. Many other additional or alternative features are also possible within the framework of the present disclosure as defined in the appended claims.

1-16. (canceled)

17. An extrication rescue tool configured to open an extrication passage for extricating a victim in a plight, such as a car wreck or a collapsed building, the extrication rescue tool comprising:
an extendable element selectively extendable by a drive along an extension path and configured to forcibly maintain or enlarge an extrication passage to allow extrication of the victim through the extrication passage when the extendable element is extended; and
an illuminator associated with, and oriented along the extension path of, the extendable element, and configured to project illumination in a shape on an edge of the extrication passage to enable identification of obstacles in the extension path, based on disturbance by the obstacle, of the shape projected by the illuminator on the edge of the extrication passage,
wherein the illuminator is arranged on a distal end of the extendable element,
wherein at least one saddle adapter is one of: (a) selectively arrangeable on a distal end of the extendable element and comprises at least one through opening to pass illumination from the illuminator therethrough, and (b) incorporated into the saddle adapter.

18. The extrication rescue tool of claim 17, wherein the illuminator is configured to project the illumination having a shape comprising at least one of a dot, a circle line, a circle with an illuminated interior, a circle with illuminated exterior, a cross hair, and combinations thereof.

19. The extrication rescue tool of claim 17, wherein at least one of a shape, size and dimension of the pattern coincides with a shape, form or size of a front of the extendable element.

20. The extrication rescue tool of claim 17, wherein the illuminator is arranged on a housing from which the extendable element is at least extendable, and into which the extendable element is also retractable.

21. The extrication rescue tool of claim 17, wherein the illuminator is arranged on the extendable element.

22. The extrication rescue tool of claim 17, wherein the illuminator comprises a laser.

23. The extrication rescue tool of claim 17, further comprising a sensor to detect a reflection from an obstacle in the extrication passage and/or edges of the extrication passage.

24. The extrication rescue tool of claim 23, further comprising a control configured to determine, based on a detection signal from the sensor, a distance between a distal end of the extendable element and said obstacle in the extrication passage and/or said edges of the extrication passage.

25. The extrication rescue tool of claim 24, wherein the control is configured to generate a warning if the determined distance is larger than a length of the tool with the extendable element in a fully or near full extended state.

26. The extrication rescue tool of claim 24, wherein the control is connected to the drive, and the control is configured to accelerate the drive when the determined distance is more than a predetermined threshold value for acceleration, and is further configured to decelerate the drive if the determined distance is less than a predetermined threshold value for deceleration.

27. The extrication rescue tool of claim 17, wherein the drive is selected from the list comprising: a hydraulic cylinder, wherein the extendable element is a piston rod; an electric motor, wherein the extendable element is one of a spindle and a tooth rack or the like; and a linear actuator.

28. The extrication rescue tool of claim 17, wherein the extrication rescue tool is an apparatus selected from the group comprising a ram, a shoring tool and a power strut.
